(19) United States
(12) Patent Application Publication
(10) Pub. No.: US 2021/0158174 A1
(43) Pub. Date: May 27, 2021

(54) EQUIPMENT MAINTENANCE ASSISTANT TRAINING BASED ON DIGITAL TWIN RESOURCES

(71) Applicant: INTERNATIONAL BUSINESS MACHINES CORPORATION, Armonk, NY (US)

(72) Inventors: Lisa Seacat DeLuca, Baltimore, MD (US); Heena Purohit, Cambridge, MA (US)

(21) Appl. No.: 16/693,575

(22) Filed: Nov. 25, 2019

(51) Int. Cl. G06N 5/00; G06F 16/23; G06F 16/242; G06N 20/00; G06N 5/04

(52) U.S. Cl. CPC G06N 5/003; G06F 16/2379; G06N 5/04; G06N 20/00; G06F 16/243

(57) ABSTRACT

A method, computer system, and a computer program product for triggering a training of a knowledge base based on a change to a physical asset is provided. The present invention may include receiving the change to one or more digital twins associated with the physical asset. The present invention may then include modifying one or more selected digital twin resources associated with the one or more digital twins associated with the physical asset based on the received change, wherein the one or more selected digital twin resources are included in the knowledge base. The present invention may also include training the knowledge base based on the modified one or more selected digital twin resources.

### BACKGROUND

The present invention relates generally to the field of computing, and more particularly to data ingestion for equipment maintenance.

Equipment Maintenance Assistant (EMA), also known as IBM Maximo® (IBM Watson and all IBM Maximo-based trademarks and logos are trademarks or registered trademarks of International Business Machines Corporation and/or its affiliates) Assist, training for Asset Performance Maintenance (APM) or Enterprise Asset Management (EAM) systems may utilize artificial intelligence (AI) services (e.g., IBM Watson® Discovery (IBM Watson and all IBM Watson-based trademarks and logos are trademarks or registered trademarks of International Business Machines Corporation and/or its affiliates) and IBM Watson® Knowledge Studio) and advanced Bayesian networks to train EMA based on work orders, service alerts, and other relevant information to assist a technician or operator and field service teams perform an assigned job.

### SUMMARY

Embodiments of the present invention disclose a method, computer system, and a computer program product for triggering a training of a knowledge base based on a change to a physical asset. Embodiments of the present invention may include receiving the change to one or more digital twins associated with the physical asset. The present invention may then include modifying one or more selected digital twin resources associated with the one or more digital twins associated with the physical asset based on the received change, wherein the one or more selected digital twin resources are included in the knowledge base. The present invention may also include training the knowledge base based on the modified one or more selected digital twin resources.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for training an equipment maintenance assistant (EMA) according to at least one embodiment;

FIG. 3 is an operational flowchart illustrating a process for querying an equipment maintenance assistant (EMA) according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a system, method and program product for determining when to trigger the training of a knowledge base based on a piece of change data associated with a change to a physical asset. As such, embodiments of the present invention have the capacity to improve the technical field of data ingestion by training a knowledge base for an equipment maintenance assistant (EMA) for field technicians, and other persons, based on the available digital twin resources associated with an asset, and updating, over time, the digital twin representation of the asset. More specifically, the EMA program may receive a change associated with an asset that may be initiated by a customer, and the digital twin(s) associated with the asset is updated. The EMA program may then add resources associated with the change to the corpus of available information for the asset, and the added resources may be utilized to, overtime, re-train the knowledge base that includes the corpus of available information on the asset.

As previously described, Equipment Maintenance Assistant (EMA), also known as IBM Maximo® Assist, training for Asset Performance Maintenance (APM) or Enterprise Asset Management (EAM) systems may utilize artificial intelligence (AI) services and IBM Watson® Knowledge Studio) and advanced Bayesian networks to train EMA based on work orders, service alerts, and other relevant information to assist a technician or operator and field service teams perform an assigned job.

However, the training for EMA (e.g., IBM Maximo® Assist) may be done by an asset owner or subject matter expert (SMEs) selecting individual files that may be useful for a system. Therefore, it may be advantageous to, among other things, continuously train EMA on digital twin resources associated with the physical asset. As such, a knowledge base may be trained for personal assistants associated with field service technicians (e.g., IBM EMA offering) based on the resources that are available and updated over time through digital twin representation of the physical asset.

Furthermore, the EMA program may significantly reduce friction for clients onboarding with solutions, such as EMA, by simplifying the document ingestion process, since the EMA program may utilize one or more digital twins, and continuously modify a physical asset over the life cycle with the digital twin to adjust the corpus of available information to train EMA.

According to at least one embodiment, the customer may initiate an instance (i.e., change) of the EMA program (i.e., field technician personal assistant program). The EMA program may reduce mean time to repair (MTTR), reduce troubleshooting time, provide recommended actions, parts, materials and tools, address knowledge gap created by an aging workforce allowing novice technologies to act with expertise of experienced technician, increase technician efficiency, enhance mean time between failure (MTBF) rate through recommended actions, and improve first time to fix (FTTR) rate. In the present embodiment, the EMA program may ensure that safety guidelines and procedures may be followed, and may further enable a technician to ask questions associated with the physical asset (i.e., asset) and historical data while performing the asset repair, inspection or related activities. The EMA program may also standardize maintenance processes in an organization.

According to at least one embodiment, the customer may associate the EMA program with available assets, optionally performed through an enterprise asset management tool (e.g., IBM Maximo® EAM), that may augment the EMA program for continuous learning thereby assist with improving failure diagnosis and offer prescriptive guidance on the most effective repair to reduce costs and extend the life cycle of the asset.

In the present embodiment, the customer may include one or more digital twins associated with the available assets.

According to at least one embodiment, the EMA program may include a digital twin with base information on the asset. The base information from the digital twin resources (i.e., base digital twin resources) may include digital agreements, user/operating manuals, Bill of Material, warranty information, warranty claims, maintenance plans, maintenance history, part replacement/usage history, specifications, three-dimensional (3D) models/ computer-aided design (CAD) drawings, fault codes, scheduled maintenance plans, usage (e.g., Internet of Things (IoT) sensor readings), operating history, owner, change of ownership, safety notifications/alerts, repair procedures, and troubleshooting tips. In the present embodiment, any changes associated with the base digital twin resources may be utilized to determine whether there was a change to the digital twin associated with a physical asset.

According to at least one embodiment, when the physical asset is used, the EMA program may update the digital twin to include data specific to the change of the asset to mimic a similar or same state as the physical asset. The data specific to the change may include Internet of Things (IoT) sensor readings associated with IoT devices from the physical asset, maintenance performed, work order completed, parts replaced, AI predictions and description of the failure (e.g., including any external data that may impact failure of the asset, such as weather). In the present embodiment, the data may include documents, images, audio files and any other format of transmitting data. The present embodiment may include associating the digital twin with the personal assistant.

According to at least one embodiment, upon association of the digital twin with the personal assistant, a digital depositor persona may select one or more digital twin resources that includes the updated data. The selected resources may then be added to the corpus of available information for the asset and may be used to train the knowledge base. As such, overtime, as new resources are added to the digital twin (including updated and/or removed), the knowledge base may be retrained to reflect the latest digital twin resource changes. Additionally, as the digital twin is updated, the EMA program may answer more contextual details regarding the asset and the corresponding usage of the asset.

According to at least one embodiment, a field technician may query the EMA program. The EMA program may utilize a search engine to parse through the knowledge base to retrieve the applicable answer to the query of the field technician. The corpus of information from the knowledge base may be used to provide a response to the field technician based on the updated digital twin resources.

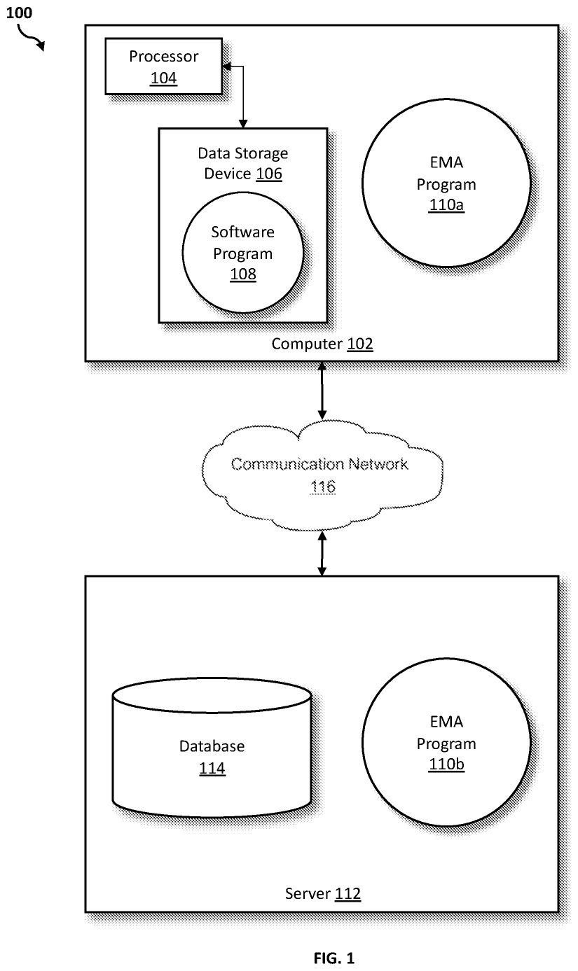

Referring to FIG. 1, an exemplary networked computer environment 100 in accordance with one embodiment is depicted. The networked computer environment 100 may include a computer 102 with a processor 104 and a data storage device 106 that is enabled to run a software program 108 and an EMA program 110a. The networked computer environment 100 may also include a server 112 that is enabled to run an EMA program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

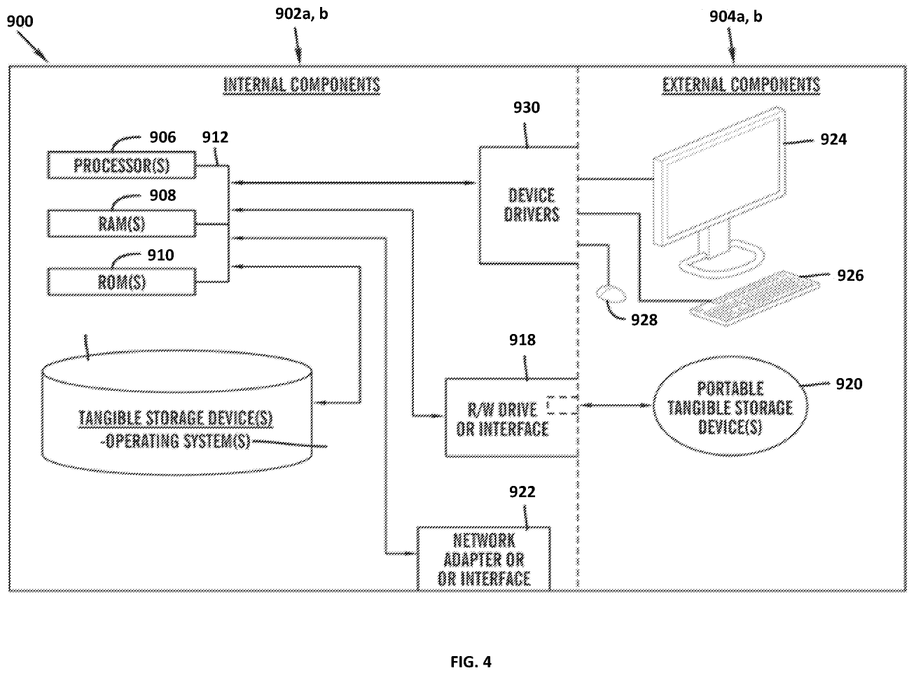

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Blockchain as a Service (BaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the EMA program 110a, 110b may interact with a database 114 that may be embedded in various storage devices, such as, but not limited to a computer/mobile device 102, a networked server 112, or a cloud storage service.

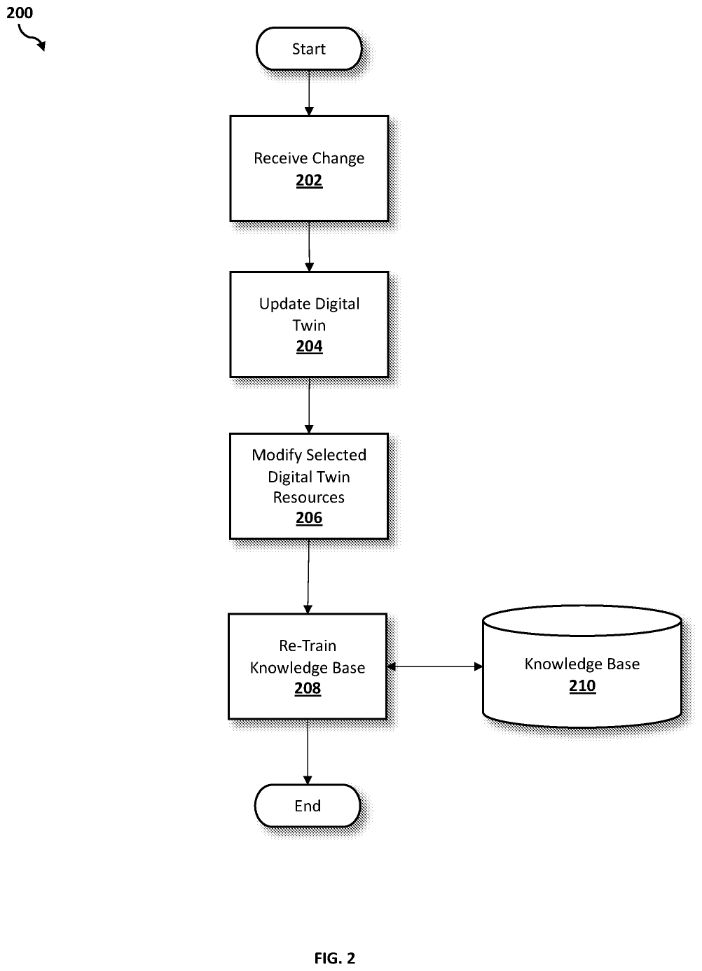

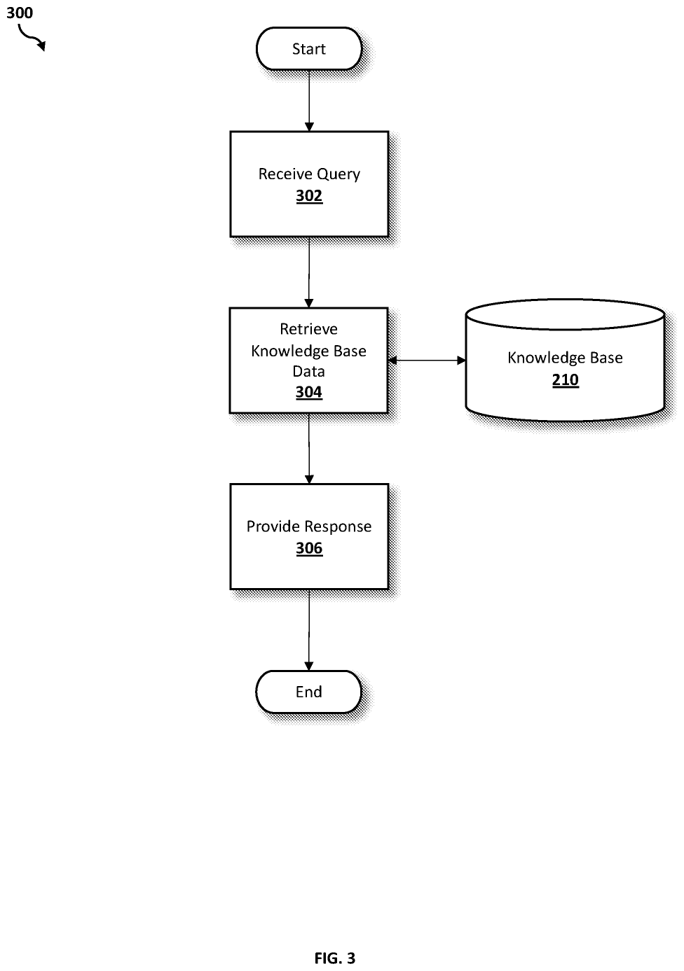

According to the present embodiment, a user using a client computer 102 or a server computer 112 may use the EMA program 110a, 110b (respectively) to ingesting a piece of change data associated with a modification (i.e., change) to a physical asset. The EMA method is explained in more detail below with respect to FIGS. 2 and 3.

Referring now to FIG. 2, an operational flowchart illustrating the exemplary EMA training process 200 used by the EMA program 110a, 110b according to at least one embodiment is depicted.

At 202, a change is received. To start the EMA training process 200, a customer may initiate (i.e., detect or activate) a change for EMA program (i.e., the field technician personal assistant) by utilizing a software program 108 on the user's device (e.g., user's computer 102), the change may be transmitted as input into the EMA program 110a, 110b via the communication network 116. The change may include details associated with the available physical assets (i.e., assets) that the customer may associate with the EMA program 110a, 110b, as well as information associated with a work order, assignment and/or job performed on the asset by previous field technician. The information (i.e., asset data from the knowledge base 210, or knowledge base data) may include any personal observations made by one or more previous field technicians (e.g., any asset part should be serviced shortly, the asset should be placed in a different location to prevent any further malfunctions or performance interruptions), details of the work performed by any previous field technicians, and/or any additional recommendations by any previous field technicians (e.g., decommission the asset, order additional asset parts, contact the manufacturer or another specialist).

In at least one embodiment, the EMA program 110a, 110b may include a hyperlink on the name of each previous field technician that performed an assignment and/or job on the asset. As such, the customer and/or another field technician may click on the hyperlink on the previous field technician to retrieve information associated with that particular field technician and/or the vendor and/or company associated with the previous field technician (e.g., address, contact information, preferred method of contact, past history of responsive times success rates in previous assignments, years of experience, any customer reviews, and rating or performance score associated with the previous field technician, actions performed on the action by the field technician and related attachments, if any). In at least one embodiment, the ratings may include two categories “Recommended,” or “Not Recommended,” which each past customer may indicate one of the two categories. The EMA program 110a, 110b may include a visual representation indicating how many customers indicated each of the two categories for that field technician. In one other embodiment, the EMA program 110a, 110b may compute a performance score (e.g., normalized quantity ranging from 0-1, 0-10, 0-100) for each previous field technician. In some embodiment, the performance score may be computed as a percentage (e.g., normalized quantity ranging from 0-100%). The higher the performance score (e.g., numeric value or percentage), the more recommended the field technician (e.g., Field Technician A with a 8.7 out of 10 performance score will be considered more recommended than Field Technician B with a 5.8 out of 10 performance score). The performance score may be determined based on an average (i.e., mean), or median of the performance scores provided by each customer for that particular field technician.

In at least one embodiment, the customer may utilize an enterprise asset management tool (e.g., IBM Maximo® EAM) to associate the available physical assets in one or more instances (i.e., one or more changes). The enterprise content or data management tool may augment the EMA program 110a, 110b for continuous learning thereby assist with improving failure diagnosis and offer prescriptive guidance on the most effective repair to reduce costs and extend the life cycle of the asset. In one embodiment, the one or more available assets may include one or more digital twin associated with each available asset, which may be associated by the customer.

In the present embodiment, each digital twin associated with the available asset may include base information (i.e., digital twin resources) on the available asset. The digital twin resources may include digital agreements, user/operating manuals, Bill of Material, warranty information, warranty claims, maintenance plans, maintenance history, part replacement/usage history, specifications, three-dimensional (3D) models/ computer-aided design (CAD) drawings, fault codes, scheduled maintenance plans, usage (i.e., Internet of Things (IoT) sensor readings), operating history, owner, change of ownership, safety notifications/alerts, repair procedures, and troubleshooting tips.

For example, Company RT purchased a brand new underground mining truck, Truck RT, from Manufacturer S. Company RT saves any information to the physical assets, including trucks, on the EMA program 110a, 110b. Therefore, the Company RT detects a change, on the EMA program 110a, 110b, to indicate that Truck RT has been purchased. Truck RT also has two digital twins, Digital Twin RT₁ and Digital Twin RT₂.

Next, at 204, the digital twin is updated. Utilizing a software program 108 in the user's device (e.g., user's computer 102), the EMA program 110a, 110b may receive, as input, data associated with the change and/or modification (i.e., change data) to the asset via the communication network 116. The change data may be generated by IoT sensor readings associated with the asset, or information provided by a field technician associated with maintenance performed, work orders completed, parts replaced and/or removed, artificial intelligence (AI) predictions, and/or any failure descriptions that is uploaded onto the EMA program 110a, 110b. In at least one embodiment, the field technician may manually enter the information into the EMA program 110a, 110b. In at least one other embodiment, the EMA program 110a, 110b may upload the information by scanning one or more tags associated with the asset. As such, when the EMA program 110a, 110b retrieves the change data associated with a change and/or modification on the asset, the corresponding digital twin(s) may be updated, by the EMA program 110a, 110b, to mimic the same state as the asset.

Continuing the previous example, upon first time scanning the tag for Truck RT, the EMA program 110a, 110b pulls up the change data, which is the digital twin resources associated with Digital Twin RT₁ and Digital Twin RT₂.

Then, at 206, selected digital twin resources are modified. The EMA program 110a, 110b may first associate the one or more digital twins corresponding with the asset with the change data. In at least one embodiment, the asset owner or subject matter expert (SME) that trains EMA program 110a, 110b on individual files may benefit from acting as the digital depositor persona, as well as may benefit from simultaneously selecting one or more digital twin resources (i.e., one or more resources from one or more digital twins) that includes the change data. In one other embodiment, the digital depositor persona may select the one or more digital twin resources consecutively after the EMA program 110a, 110b associates the one or more digital twins.

The selected digital twin resources may be added that includes the changes and/or modifications provided by the change data to the corpus of available information for the asset.

In at least one embodiment, the EMA program 110a, 110b may remove selected digital twin resources in which the information provided in the resource in outdated and/or no longer relevant to the asset associated with the digital twin. For example, if Asset A has a new operating manual that includes new troubleshooting tips, then the EMA program 110a, 110b will remove the previous operating manual as a digital twin resource, and replace the previous operating manual with a new operating manual.

Continuing the previous example, the digital twin resources associated with the Digital Twin RT₁ and Digital Twin RT₂, which includes 10 different documents for each digital twin. The 10 different documents include Bill of Materials, technical drawings, regulatory standard documents, maintenance tool specification, standard of use documentation, list of places where equipment was installed, engineering knowledge base, operating manuals, troubleshooting tips, and fault codes are imported into the corpus of available information for Truck RT.

Then, at 208, the knowledge base is re-trained. The digital twin resources may be included in a knowledge base 210 (e.g., database 114). Due to the addition and/or removal of digital twin resources, the knowledge base 210 may be periodically re-trained to reflect the latest digital twin resource modifications and/or changes in order to manage the content in the knowledge base 210. The knowledge base 210 may be re-trained by refreshing the documents based on the updated digital twin resources.

In at least one embodiment, when the digital twin is updated, the EMA program 110a, 110b may answer more contextual details associated with the asset and the usage of the asset (i.e., asset usage).

In at least one embodiment, the EMA program 110a, 110b may be triggered, or driven, to re-train the knowledge base 210 by various key asset events associated with the digital twin, such as: a specific sensor reading (e.g., when a value is higher than a threshold set), hours of operation (e.g., perform a retrain when the asset has been used for 10 hours since the last update), after a specific type of job request is performed (e.g., recall as opposed to routine maintenance), a type/severity of new resource available (e.g., a manufacturer pushed warranty or safety recall bulletin that may make available to service technicians and reliability engineers).

In at least one other embodiment, if such a type of digital twin file is modified and /or added, then the EMA program 110a, 110b may be triggered to retrain the knowledge base 210. For example, after a specific number of work orders are performed, or after a field technician with an expertise threshold performs a change. As such, if an expert performs a set of changes to an asset, those changes may be used to instruct, or teach, more junior technicians. Therefore, the knowledge base 210 may be updated sooner rather than later, such as after someone who is not as skilled performs a modification and/or change on the asset.

In at least one other embodiment, the EMA program 110a, 110b may be triggered to retrain the knowledge base 210 based on weather specific events. For example, once the weather drops to below freezing, retrain the knowledge base 210 with any changes since the last updates.

In some embodiments, the EMA program 110a, 110b may be triggered to retrain the knowledge base 210 if certain conditions occur, such as a specific type of the one or more selected digital twin resource is modified, a threshold number of the one or more selected digital twin resources are modified, and a preferred amount of time has lapsed from a last update associated with the one or more digital twins.

In at least one embodiment, the EMA program 110a, 110b may include two knowledge bases 210 (i.e., database 114): a global knowledge base 210 and a local knowledge base 210. The global knowledge base 210 may be located in a cloud application or system, and may receive feedback from field technician and updates to the digital twins associated with the EMA program 110a, 110b. The local knowledge base 210 may be located on the user's device or user's computer 102 may include the same data as the global knowledge base 210. The global knowledge base 210 may regularly synchronize with the local knowledge base 210. Alternatively, the synchronization of the knowledge bases 210 may be configured. For example, the updates may be pushed when the EMA program 110a, 110b may detect that newer updates are available in the local knowledge base 210.

Continuing the previous example, the new files for Digital Twin RT₁ and Digital Twin RT₂ from Truck RT are utilized to re-train knowledge base 210 associated with the EMA program 110a, 110b.

Referring now to FIG. 3, an operational flowchart illustrating the exemplary EMA querying process 300 used by the EMA program 110a, 110b according to at least one embodiment is depicted.

At 302, a query is received. Utilizing a software program 108 on the user's device (e.g., user's computer 102), a field technician (e.g., field service technician, technician, service technician) may upload a query (i.e., question) onto the EMA program 110a, 110b. For example, on the main screen of the EMA program 110a, 110b, the field technician will be prompted, via a dialog box, to include in natural language a query associated with an asset. In at least one embodiment, if the query, or the asset that the query associated with, is unclear, the EMA program 110a, 110b may prompt (e.g., via a dialog box) the field technician by requesting additional information to appropriately address the query received. In at least one embodiment, the EMA program 110a, 110b may include a list of previously submitted queries or frequently asked questions, or a list of previously inquired assets or frequently inquired assets, (e.g., via a drop box) in which the field technician may review and utilize to submit a query to the EMA program 110a, 110b.

In at least one embodiment, the EMA program 110a, 110b may first prompt (e.g., a dialog box) the field technician to identify the asset to which the query may direct to, and then the EMA program 110a, 110b may prompt (e.g., via an expanded dialog box) to provide the query associated with identified asset.

In other embodiment, one person, other than a field technician, may provide the query to the EMA program 110a, 110b.

Continuing the previous example, a brand new field technician, Technician T, performs maintenance on Truck RT and submits a query to the EMA program 110a, 110b to determine how to change the oil on the Truck RT.

Next, at 304, knowledge base data is retrieved from the knowledge base 210. The EMA program may utilize a search module to parse through the knowledge base 210 to retrieve the knowledge base data (e.g., data in the knowledge base 210 that may be associated with the physical asset, or asset data) associated with the query submitted by the field technician. The search module may utilize an analyzer to use natural language processing (NLP) techniques (e.g., structure extraction, language identification, tokenization, decompounding, lemmatization/stemming, acronym normalization and tagging, entity extraction, phrase extraction) to analyze through the textual data included in the corpus of available information associated with the asset in the knowledge base 210. Then, individual words, phrases, and/or sentences, as well as the relationships between the individual words, phrases and/or sentences, may be extracted from the textual data by utilizing various extraction approaches (e.g., top down, bottoms up, statistical). As a result, the analyzer may interpret the context and meaning for the words, phrases and/or sentences parsed by the textual data. In at least one embodiment, the analyzer may utilize key words included in the query provided by the field technician to match with the corpus of available information included in knowledge base 210.

In one other embodiment, the analyzer may utilize one or more image recognition and processing tools (e.g., convolutional neural networks (CNNs), pattern recognition) to identify objects shown in an image (e.g., diagram). In various image recognition and processing tools, an image may be broken down in a number of tiles that is individually analyzed, or classified into objects or classes based on features, to determine the identity of the objects presented in the image. The analyzer may match the identified objects in the image with the key words of the query to determine whether the image may be utilized to respond to the query submitted by the field technician.

Continuing the previous example, the EMA program 110a, 110b utilizes IBM Watson® Discovery to find references to changing the oil in the digital twin resources from Digital Twin RT₁ and Digital Twin RT₂.

Then, at 306, a response is provided. When the EMA program 110a, 110b identifies one or more pieces of asset data from the knowledge base 210 (i.e., knowledge base data) that may serve as a response to the query submitted by the field technician, the EMA program 110a, 110b may present, based on the re-trained knowledge base 210, the pieces of asset data, from the knowledge base 210, to the field technician in the form of a list and/or visual representation for the field technician to select one or more piece of asset data, from the knowledge base 210, to review and determine whether that piece of asset data, from the knowledge base 210, responded to the query.

In at least one embodiment, the responses may be provided as a visual response and/or an audible (i.e., voice) response. A visual response may be indicated by displaying the response on a mobile device, a website, or through the physical asset itself, by utilizing a change in color, a written message, or other form of visual representation. In at least one other embodiment, an audible response may include a vibration, or an audible message.

In at least one embodiment, the EMA program 110a, 110b may calculate a confidence score for the pieces of asset data, from the knowledge base 210, generated in response to the query submitted by taking half of the size of the confidence interval, and multiplying half of the size of the confidence interval by the square root of the sample size and then dividing that result by the sample standard deviation. In one other embodiment, the EMA program 110a, 110b may compute a confidence score (e.g., normalized quantity ranging from 0-1, 0-10, 0-100) for each piece of asset data, from the knowledge base 210, retrieved in response to the query . In some embodiment, the confidence score may be computed as a percentage (e.g., normalized quantity ranging from 0-100%). The higher the confidence score (e.g., numeric value or percentage), the more relevant the piece of asset data, from the knowledge base 210, to the query submitted (e.g., Reference A with a 65% out of 100% confidence score will be considered more relevant to the query than Reference B with a 34% confidence score). In one embodiment, the EMA program 110a, 110b may rank the piece of asset data, from the knowledge base 210, in order of the piece of asset data, from the knowledge base 210, with the highest confidence score to the piece of asset data, from the knowledge base 210, with the lowest confidence score.

Continuing the previous example, the IBM Watson® Discovery find four references to changing the oil in the Truck RT in the Operating Manual. Technician T clicks on the option with the highest confidence score, which was confidence score of 96% and was a part of resources associated with Digital Twin RT₁. The EMA program 110a, 110b then provides the following response: “First, unscrew the red cap on the right side of the engine.” The EMA program 110a, 110b further provides a visual representation of the location of the red cap on the right side of the engine. Therefore, Technician T was able to change the oil on the Truck RT with the skills of an expert, despite having never done it before.

In the present embodiment, feedback from the field technician (i.e., feedback) may be utilized by the EMA program 110a, 110b to determine the effectiveness of the provided response, including pieces of asset data, from the knowledge base 210, to the query. The EMA program 110a, 110b may prompt (e.g., via dialog box) the field technician to provide feedback in which the field technician may provide comments associated with the usefulness of the EMA program 110a, 110b. In some embodiments, the field technician may provide a score (i.e., normalized quantity from 1 to 10) on the effectiveness of the EMA program 110a, 110b, as well as provide comments to further explain the reason for the score given. Based on the feedback, the EMA program 110a, 110b may determine whether the piece of asset data, from the knowledge base 210, and/or digital twin resources may be re-evaluated or modified. In at least one embodiment, the feedback may be utilized to determine whether knowledge base 210 should be re-trained.

In some embodiments, the field technician may be prompted by at least two forms of notification (e.g., via dialog box) to provide feedback simultaneously to when the response(s) is provided at 208. In other embodiments, the response(s) may be presented at 208 first and then field technician may be prompted to provide feedback shortly thereafter.

In the present embodiment, the field technician may opt out of providing feedback for a particular response. When prompted (e.g., via dialog box) to provide feedback, the field technician may click, for example, the “Ignore” button located at the bottom of the dialog box. Then, the dialog box may disappear. In some embodiments, the field technician may command a virtual assistant or audio-enabled device to ignore the feedback request from the EMA program 110a, 110b.

In some embodiments, the EMA program 110a, 110b may preclude the field technician from not providing at least one feedback for a certain time period or certain number of provided responses. In at least one embodiment, the default may be three (3) consecutive provided responses. As such, if the field technician fails to provide feedback for three consecutive provided responses, then the field technician may not be provided with the “Ignore” button or option when the next response is provided for another query. The field technician may have to provide feedback for that response to the next query. In another embodiment, such default may be re-configured or changed by an administrator.

In at least one embodiment, the field technician may provide feedback at any time. The field technician may select the “Feedback” button located at the bottom of the main screen to provide such feedback. Once the “Feedback” button is selected, then the field technician may be prompted (e.g., via dialog box) to provide, in a comment box, the response or general issues (e.g., no matching asset data, from the knowledge base 210, to respond to the query) that the feedback is associated with, and click the “Submit” button located at the bottom of the dialog box.

In the present embodiment, EMA program 110a, 110b may be utilized for on-premises software (i.e., on-prem) installation (i.e., the EMA program 110a, 110b may be installed and runs on computers on the premises of the person or organization using the software, rather than at a remote facility), including private, or non-IBM® (IBM and all IBM-based trademarks and logos are trademarks or registered trademarks of International Business Machines Corporation and/or its affiliates) cloud installation.

The EMA program 110a, 110b may improve the functionality of the computer, the technology and/or the field of technology by utilizing digital twin resources, which includes managing and describing a registry that holds the resources that make up one or more digital twin of a physical asset, to enhance EMA, such as reducing the mean time to repair a physical asset, and the EMA program 110a, 110b may further utilize the digital twin resources associated with the physical asset as a part of the EMA roadmap.

Additionally, the EMA may be a part of an Asset Performance Maintenance (APM) portfolio with a IBM Watson® Internet of Things (IoT), and the findings from the EMA program 110a, 110b may be integrated into the APM portfolio through a typical EMA integration. The EMA program 110a, 110b may further feed into industry specific knowledge into the corpus of available data for industrial IoT use cases.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 4. Each of the sets of internal components 902a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the EMA program 110a in client computer 102, and the EMA program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the EMA program 110a, 110b can be stored on one or more of the respective portable computer-readable tangible storage devices 920, read via the respective R/W drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the EMA program 110a in client computer 102 and the EMA program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the EMA program 110a in client computer 102 and the EMA program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure or on a hybrid cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

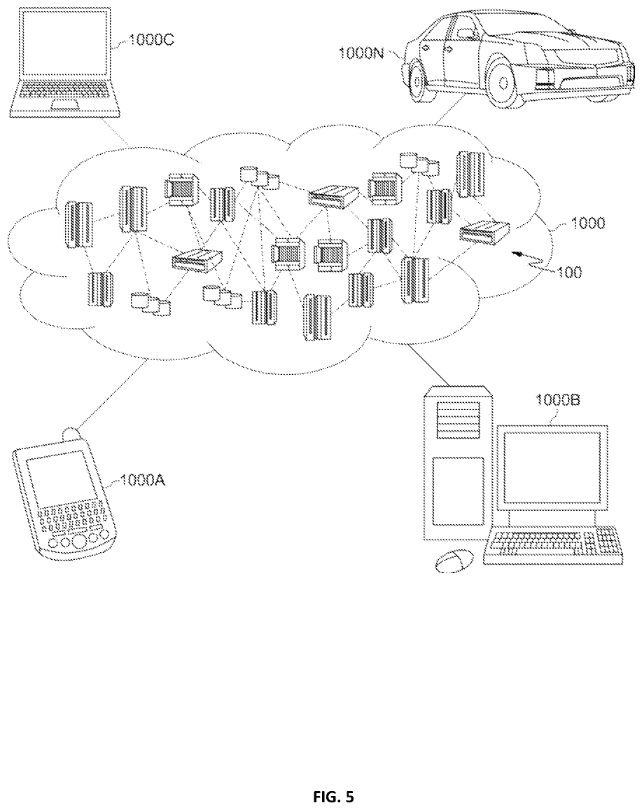

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

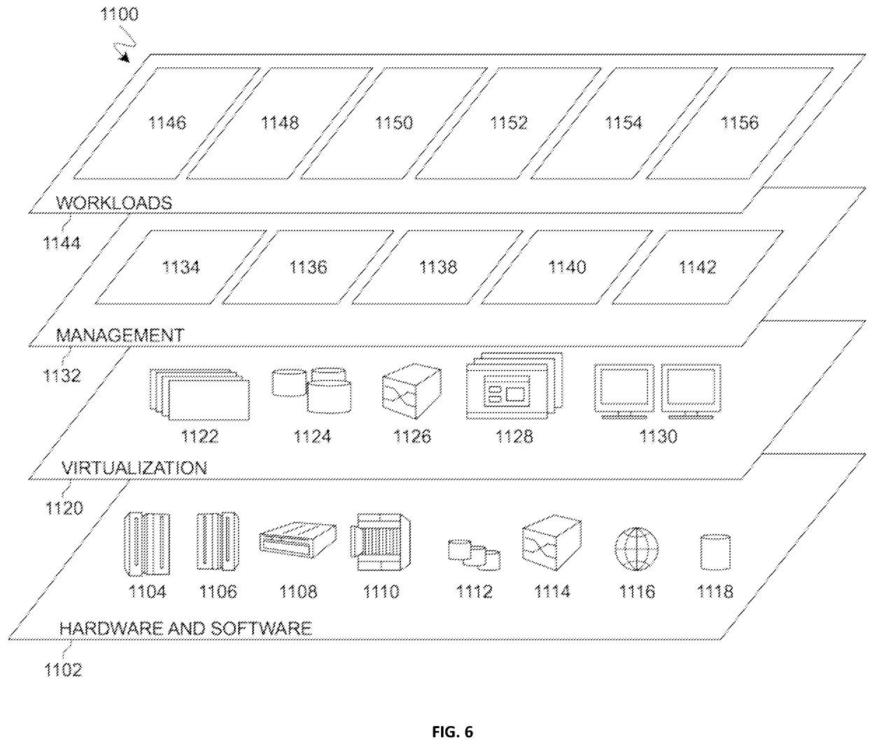

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and equipment maintenance assistant (EMA) 1156. An EMA program 110a, 110b provides a way to determining when to trigger the training of the knowledge base 210 based on the received change data associated with a modification (i.e., change) to a physical asset.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a change to one or more digital twins associated with a physical asset, modifying one or more selected digital twin resources associated with the one or more digital twins associated with the physical asset based on the change;
wherein the one or more selected digital twin resources are included in a knowledge base; and
training the knowledge base based on the modified one or more selected digital twin resources.

2. The method of claim 1, further comprising:
triggering the training of the knowledge base based on the modified one or more selected digital twin resources from one or more of the following conditions:
(i) a specific type of the one or more selected digital twin resource is modified;
(ii) one or more key asset events associated with the one or more digital twins is detected;
(iii) a threshold number of the one or more selected digital twin resources are modified; and
(iv) a preferred amount of time has lapsed from a last update associated with the one or more digital twins.

3. The method of claim 1, further comprising:
receiving a query associated with the physical asset;
retrieving one or more responses from the knowledge base; and
presenting the one or more responses.

4. The method of claim 3, wherein receiving the query associated with the physical asset further comprises:
searching the knowledge base for the one or more responses associated with the physical asset;
identifying a set of knowledge base data that corresponds with the received query by one or more of the following techniques:
(i) utilizing natural language processing (NLP) techniques associated with the one or more digital twins for the physical asset, and
(ii) one or more image recognition and processing tools; and
presenting a list of the identified set of knowledge base data,
wherein each identified set of knowledge base data includes a confidence score,
wherein the confidence score is computed to indicate a level of responsiveness that each identified set of knowledge base data is to the received query.

5. The method of claim 1 in which the change to the one or more digital twins associated with the physical asset includes one or more of:
a piece of information generated from one or more Internet of Things (IoT) sensor readings connected to the physical asset; and
a piece of information selected from a group consisted of:
(i) one or more maintenance performed;
(ii) one or more work orders completed;
(iii) one or more parts replaced;
(iv) one or more parts removed;
(v) one or more changes associated with a base digital twin resource;
(vi) one or more artificial intelligence (AI) predictions; and
(vii) one or more failure descriptions.

6. The method of claim 1, further comprising:
incorporating the modified one or more selected digital twin resources to a corpus of available information associated with the physical asset.

7. The method of claim 3, wherein receiving the query associated with the physical asset, further comprises:
identifying the asset by a technician,
wherein the query is received by the technician; and
providing, by the technician, the query associated with the identified asset.

8. The method of claim 3, wherein the presenting the one or more responses comprises one or more of:
(i) one or more visual responses; or
(ii) one or more audible responses.

9. A computer system for triggering a training of a knowledge base based on a change to a physical asset, comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
receiving the change to one or more digital twins associated with the physical asset,
modifying one or more selected digital twin resources associated with the one or more digital twins associated with the physical asset based on the change;
wherein the one or more selected digital twin resources are included in the knowledge base; and
training the knowledge base based on the modified one or more selected digital twin resources.

10. The computer system of claim 9, further comprising:
triggering the training of the knowledge base based on the modified one or more selected digital twin resources from one or more of the following conditions:
(i) a specific type of the one or more selected digital twin resource is modified;
(ii) one or more key asset events associated with the one or more digital twins is detected;
(iii) a threshold number of the one or more selected digital twin resources are modified; and
a preferred amount of time has lapsed from a last update associated with the one or more digital twins. resources.

11. The computer system of claim 9, further comprising:
receiving a query associated with the physical asset;
retrieving one or more responses from the knowledge base; and
presenting the one or more responses.

12. The computer system of claim 11, wherein receiving the query associated with the physical asset further comprises:
searching the knowledge base for the one or more responses associated with the physical asset;
identifying a set of knowledge base data that corresponds with the received query by one or more of the following techniques:
(i) utilizing natural language processing (NLP) techniques associated with the one or more digital twins for the physical asset, and
(ii) one or more image recognition and processing tools; and
presenting a list of the identified set of knowledge base data,
wherein each identified set of knowledge base data includes a confidence score,
wherein the confidence score is computed to indicate a level of responsiveness that each identified set of knowledge base data is to the received query.

13. The computer system of claim 9 in which the change to the one or more digital twins associated with the physical asset includes one or more of:
a piece of information generated from one or more Internet of Things (IoT) sensor readings connected to the physical asset; and
a piece of information selected from a group consisted of:
(i) one or more maintenance performed;
(ii) one or more work orders completed;
(iii) one or more parts replaced;
(iv) one or more parts removed;
(v) one or more changes associated with a base digital twin resource;
(vi) one or more artificial intelligence (AI) predictions; and
(vii) one or more failure descriptions.

14. The computer system of claim 9, further comprising:
incorporating the modified one or more selected digital twin resources to a corpus of available information associated with the physical asset.

15. The computer system of claim 11, wherein receiving the query associated with the physical asset, further comprises:
identifying the asset by a technician,
wherein the query is received by the technician; and
providing, by the technician, the query associated with the identified asset.

16. The computer system of claim 11, wherein the presenting the one or more responses comprises one or more of:
(i) one or more visual responses; or
(ii) one or more audible responses.

17. A computer program product for triggering a training of a knowledge base based on a change to a physical asset, comprising:
one or more computer-readable tangible storage media and program instructions stored on at least one of the one or more computer-readable tangible storage media, the program instructions executable by a processor to cause the processor to perform a method comprising:
receiving the change to one or more digital twins associated with the physical asset,
modifying one or more selected digital twin resources associated with the one or more digital twins associated with the physical asset based on the change;
wherein the one or more selected digital twin resources are included in the knowledge base; and
training the knowledge base based on the modified one or more selected digital twin resources.

18. The computer program product of claim 17, further comprising:
receiving a query associated with the physical asset;
retrieving one or more responses from the knowledge base; and
presenting the one or more responses.

19. The computer program product of claim 18, wherein receiving the query associated with the physical asset further comprises:
searching the knowledge base for the one or more responses associated with the physical asset;
identifying a set of knowledge base data that corresponds with the received query by one or more of the following techniques:
(i) utilizing natural language processing (NLP) techniques associated with the one or more digital twins for the physical asset, and
(ii) one or more image recognition and processing tools; and presenting a list of the identified set of knowledge base data,
wherein each identified set of knowledge base data includes a confidence score,
wherein the confidence score is computed to indicate a level of responsiveness that each identified set of knowledge base data is to the received query.

20. The computer program product of claim 17 in which the change to the one or more digital twins associated with the physical asset includes one or more of:
a piece of information generated from one or more Internet of Things (IoT) sensor readings connected to the physical asset; and
a piece of information selected from a group consisted of:
(i) one or more maintenance performed;
(ii) one or more work orders completed;
(iii) one or more parts replaced;
(iv) one or more parts removed;
(v) one or more changes associated with a base digital twin resource;
(vi) one or more artificial intelligence (AI) predictions; and
(vii) one or more failure descriptions.
